(19) United States
(12) Patent Application Publication
(10) Pub. No.: US 2003/0057262 A1
(43) Pub. Date: Mar. 27, 2003

(54) Method for connecting two components by means of friction welding and a machine element produced according to said method

(76) Inventor: Heinz Karl Klampfl, Barnbach (AT)

Correspondence Address: Bachman & LaPointe, Suite 1201, 900 Chapel Street, New Haven, CT, 06510-2802, US

(21) Appl. No.: 10/182,274

(22) PCT Filed: Jan. 26, 2001
(86) PCT No.: PCT/AT01/00021

(30) Foreign Application Priority Data
Jan. 26, 2000 (AT) GM 46/2000

(51) Int. Cl. B23K 20/12

(52) U.S. Cl. 228/112.1

(57) ABSTRACT

A method of joining a first part (1) to a second part (2) by friction welding consists in the following steps:

a) the second part (2) is provided with a through bore (5) which is normal to the second contact face (4) and is larger than the diameter of the joining part,

b) the two parts (1, 2) are brought into contact, positioned in relation to each other and firmly clamped in a friction welding machine (8),

c) as a joining part, a joining pin (6) is firmly clamped in the other clamping device (9) of a friction welding machine,

d) the friction welded joint (11) is produced between the end face of the joining pin (6) and the first part (1).

In order to permit accurate positioning and the transmission of thrust forces, the welding bead (10) produced in this way in the space (7) between the bore (5) and the joining pin (6) forms a form-fitting joint. The method is particularly suitable for permanently joining rotating machine elements.

The invention relates to a method of joining a first part to a second part, the first part having a first contact face and the second part having a second contact face, which are cylindrical and touch each other when joined, by means of frictional welding with circularly symmetrical joining parts, consisting in the following steps:

a) the second part is provided with a through bore which is normal to the second contact face,

b) the two parts are brought with their machined contact faces (3, 4) into contact and, positioned in relation to each other, are firmly clamped in a friction welding machine,

c) as a joining part, a joining pin having an end face is firmly clamped in the other clamping device of a friction welding machine,

d) the joining pin is inserted into the bore until it reaches the first contact face and then, under rotation, a friction welded joint is produced between the end face of the joining pin and the first part,

e) after the welding has been completed, the joining pin remains at least partly in the bore.

The contact faces are cylindrical faces, at least one of the parts to be joined is therefore circularly symmetrical, preferably a shaft with a body fixed thereto, for example a gear, a hub or with an eccentric balancing body. The joint can, by the way, be produced both by means of one joining part or by means of several joining parts.

A method of this type is disclosed by U.S. Pat. No. 3,477,115. In this method, two plates are joined by means of a rivet-like pin. Following welding, the head of the joining pin is seated on the second part, so that the two parts are seated firmly on each other. The joint produced in this way is similar to a riveted joint, in which the two parts are pulled together, a certain frictional connection also being produced between them. For permanent accurate position and the transmission of, in particular pulsating, forces transversely with respect to the axis of the pin, such a joint is not suitable. In the case of rotationally symmetrical parts, such transverse forces arise during the transmission of a torque.

In this case, the joining pin is also under tensile stress and the joined parts are under compressive stress, which can lead to distortion of the parts. This also means restrictions in the choice of the welding parameters, as a result of which the method is primarily usable in the sheet-metal sector; for thicker parts, special requirements and materials which are difficult to weld, it is not suitable, however.

Machine elements produced by this method are therefore not permanently accurately joined, from time to time distorted, which is forbidden in rotating machine elements and not suitable at all for the transmission of a torque. The invention therefore also concerns machining elements produced according to the invention.

U.S. Pat. No. 3,495,321 discloses a method of joining two thin flat parts by means of a pin by friction welding, the pin being pushed through into an opening in the upper of the two parts and the friction welded joint between the pin and the two parts then being produced. For this purpose, the diameter of the pin and of the opening is chosen in such a way that a frictional connection is produced between the pin and the part having the opening, said frictional connection effecting heating over its length. Application of this method to the dimensionally accurate and distortion-free joining of machine elements suitable for rotating operation is not conceivable.

It is an object of the invention to provide a generic method which does not have the aforementioned disadvantages. It is intended to be quick and cheap and also suitable for thick workpieces or rotating machine elements made of different materials, and consequently supply accurate workpieces which can also transmit thrust forces or a torque. In order to minimize the distortion, as little energy as possible is also to be supplied.

In order to produce the friction welded joint in the narrower sense, the joining pin is inserted into the bore until it reaches the first contact face and then, under rotation, is pressed on, by which means the friction welded joint is produced between the end face of the joining pin and the first part.

The method according to the invention consists in that the bore is greater than the joining part, so that between bore and connecting part a space is produced, in which the welding bead produced in step d) finds space and there produces a form-fitting joint between the wall of the bore and the joining pin.

The larger bore does not need to be machined accurately, precision machining following boring is not required. If the second part is a casting, it could even remain as a raw casting. Its overdimension with respect to the joining part permits the accurate positioning of the two parts in relation to each other, without requiring excessively accurate positioning of the other clamping device (one or the other is rotatable and/or displaceable). Process-specific preparation of the first contact face of the first part for the welding is normally not required. From this point of view, the method can also be fully automated.

The overdimension also has the important consequence that the space between the joining pin and the wall of the bore accommodates the welding bead typical of friction welding. To a certain extent, the welding bead bridges the play between the two parts, fixes the positioning and forms a form-fitting joint between the joining pin and the second part, which can also absorb considerable thrust forces and torques. By means of this “expansion space”, in spite of the form-fitting joint, only very low stresses are built up in the parts. With the freedom to vary the diameter difference within wide limits, there is also much more freedom in the choice of the welding parameters, for example to match different materials. As a result, even materials which are difficult to weld, certainly even nonmetallic materials are suitable for the method of the invention.

The fact that the welding bead enlarges the joining face and therefore the thrust forces which can be transmitted, the joining part needs to be only a pin of small diameter, which further reduces the necessary welding energy and further shortens the cycle time. As a rule, a simple pin without a specially shaped end face is sufficient. It is therefore cheap and also simple to clamp in and to center. By means of special shaping of the end face, the formation of a bead and therefore the entire welding process can be influenced significantly.

In a development of the invention, the remainder of the joining pin which is no longer needed for joining the two parts and is firmly clamped in the other clamping device of the friction welding machine is separated from the part of the joining pin that produces the joint, which can be carried out without a special operation by tearing off and/or shearing off the unneeded part in a predetermined zone of the joining pin, and at a predetermined time (claim 2).

This is carried out in a particularly practical way if the joining pin has an intended fracture point (claim 4), which is preferably a circumferential groove (claim 5). The separation then takes place quite automatically if, in the last phase of the friction welding, an increased torque is applied and/or a tensile force is applied to the clamping. The intended fracture point can in this way be placed at an otherwise inaccessible point in the bore, so that the unneeded part of the joining pin does not protrude.

The invention also relates to a preferably rotating machine element which comprises a first part with a first cylindrical contact face and a second part with a second cylindrical contact face and a bore which ends in the second contact face and accommodate a joining pin, which passes through the bore and whose end face is joined to the first contact face by a friction welding zone. Here, according to the invention, the diameter of the bore, at least over part of its depth, is greater than that of the joining pin, so that between bore and joining part a space is produced in which the welding bead which is formed produces a formfitting joint between the first and second parts (claim 3). The machine element produced in this way is distinguished by high accuracy and low production costs.

Particular circumstances or combinations of materials may make it necessary for the bore of the second part to have a widening in the vicinity of the second contact face (claim 6). In this way, the flow behavior of the welding bead, the dissipation of heat, the process reliability and the characteristics of the welded joint can also be influenced. The removal of the portion can be carried out mechanically, chemically or electrically. However, the bore of the second part can also have a constriction on the side facing away from the first contact face (claim 7). This constriction can then serve to center the joining pin.

In the following text, the invention will be described and explained using figures, in which:

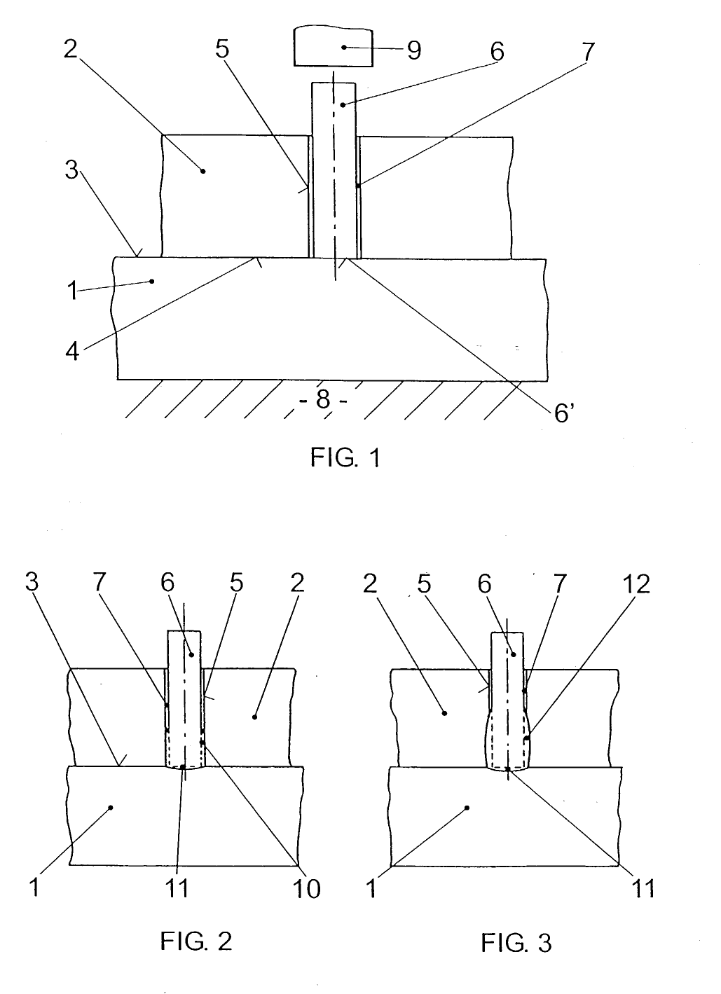

FIG. 1 shows the parts of the machine element according to the invention before welding,

FIG. 2 shows a part of a machine element according to the invention produced by the method according to the invention in a first form,

FIG. 3 shows a part of a machine element according to the invention produced by the method according to the invention in a second form,

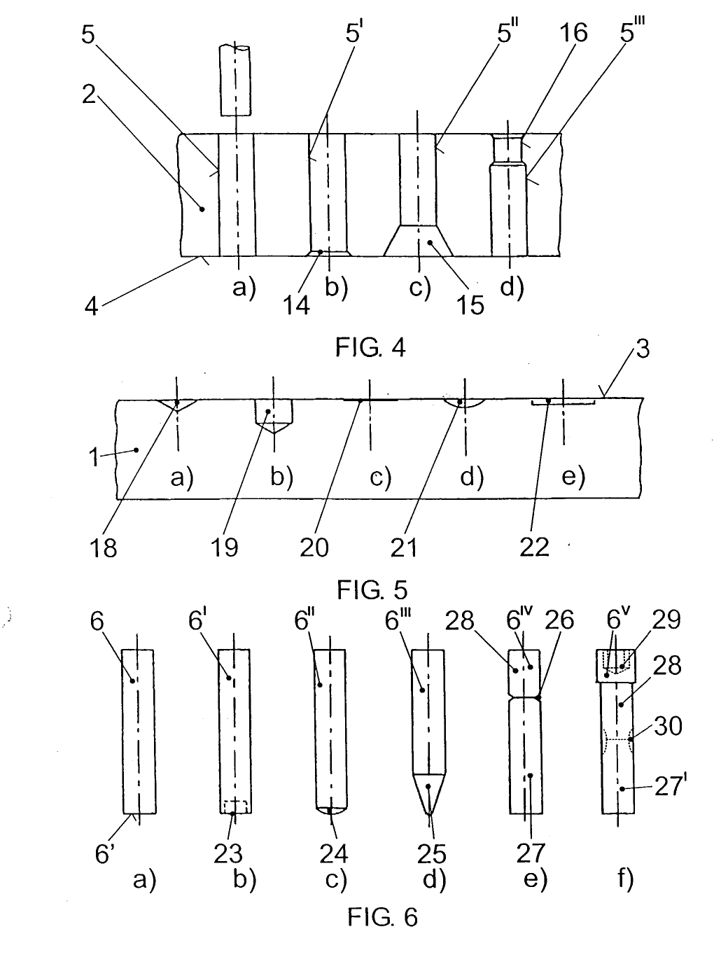

FIG. 4 shows the detail II from FIG. 1 in different variants (a to d) before welding,

FIG. 5 shows the detail III from FIG. 1 in different variants (a to f) before welding,

FIG. 6 shows the detail IV from FIG. 1 in different variants (a to e) before welding,

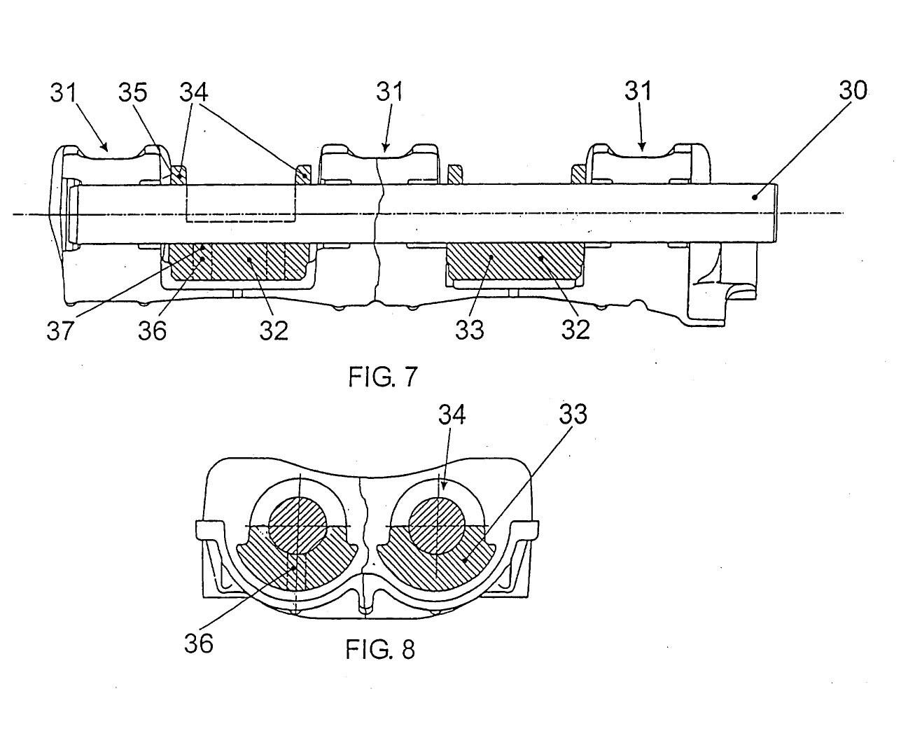

FIG. 7 shows a longitudinal section of a balancing shaft assembled by the method according to the invention and belonging to a piston machine,

FIG. 8 shows a cross section relating to FIG. 7.

FIG. 1 shows, in part, a machine element, which comprises a first part 1 and a second part 2, before welding. The parts 1, 2 can be plate-like, as illustrated, but are preferably a shaft and a hub. In the last-named case, the first contact face 3 of the first part and the second contact face 4 of the second part are flat or cylindrical. These faces are machined accurately, so that part 1 and 2 can be joined cleanly. In the case of cylindrical contact faces, this means at least a snug fit. The second part 2 has a bore 5, which permits the entry of a joining pin 6 whose end face 6′ is already seated on the second contact face 4 in the position shown. The diameter of the joining pin 6 is smaller than the internal diameter of the bore 5, so that an interspace 7 remains free between them.

The friction welding is performed by means of relative movement between the joining pin 6 and the two joined parts 1, 2. For this purpose, the latter are fixed to a clamping device 8, only indicated, of a friction welding machine, not illustrated, and the joining pin 6 is fixed to another clamping device 9 belonging to the friction welding machine. The relative movement carried out for the purpose of welding is a rotation about the axis of the joining pin 6 and an advance in the direction of this axis. These movements proceed in a defined order and in a precisely metered extent, these mechanical welding parameters being calculated or determined in the manner usual in friction welding.

The bore 5 does not require any precision machining, it can also be rough cast. The ratio between bore diameter and the diameter of the joining pin and also, if appropriate, the shape of the bore are important influencing factors for controlling the welding process. The flow behavior and the final form of the welding beam depends on them. However, also dependent on them is whether there is further welding between the rising bead and the bore 5 or merely the formation of a form-fitting joint.

FIG. 2 shows the same machine element after welding. During the latter, the end face 6′ of the joining pin 6 forms a first welding zone 11 with the first contact face. The welding bead 10 produced in the process is forced down into the interspace 7 and, with the bore 5 of the second part 2, thus forms a form-fitting joint that is suitable for the transmission of a thrust force or a torque. The level to which and the manner in which the welding bead 10 fills the interspace 7 depends on the diameter ratio and the welding parameters. In this way, the joining pin 6 is welded to the first part 1 and the second part is secured against displacement of the contact faces 3, 4 in relation to each other by the joining pin 6 in the manner of a dowel pin. When selecting materials, the factor here is the ability of the joining pin 6 to be welded to the first part 1, since the second part 2 is only joined with a form fit, and can therefore consist of any desired material, which does not need to be a metal at all.

With differently chosen welding parameters, a joint according to FIG. 3 is produced. In this joint, the welding parameters and the materials are chosen in such a way that, in addition to the first welding zone 11, the welding bead 10 is also frictionally welded to the inner wall of the bore 5 in the second part 2 and therefore forms a second welding zone 12, and therefore also a welded joint between the joining pin 6 and the second part 2. The height of the second welding zone 12 depends on the width of the interspace 7 and on the welding parameters.

In the execution of both methods, the welding operation proceeds as follows: the two parts 1, 2 are joined by their prepared contact faces 3, 4. The second part 2 already has a bore 5. The two parts 1, 2 are then positioned accurately and clamped into a clamping device belonging to the friction welding machine. The joining pin 6 is then clamped in the other clamping device of the friction welding machine and inserted into the bore 5 and positioned. The joining pin 6 is then inserted into the bore 5 by means of a feeding movement on its axis until its end face 6′ touches the second contact face 4.

The actual welding operation then begins, which comprises a friction phase, a compression phase and a holding or repressurizing phase. The progress over time of the feed and rotational movements, the mechanical welding parameters, have been determined in the manner familiar to those skilled in the art. The welding bead 10, which is typical of friction welding, rises in the interspace 7 between joining pin 6 and bore 5 and either forms a form-fitting joint there, as in FIG. 2, or is also welded to the second part 2 and forms a joint as in FIG. 3.

In normal cases, the first contact face 3 does not need to be machined in a process-specific way, if the bore 5 is cylindrical and if the joining pin 6 is likewise a cylinder. In special cases or in order to optimize the joint under certain circumstances, these can be configured differently, however.

According to FIG. 4, the shape of the bore 5 can be modified, since its influence on the flow behavior of the friction bead, the specific filling behavior in the transition area between the two parts 1, 2 and on the process stability is considerable. In FIG. 4, a) shows a normal cylindrical bore 5; b) shows a cylindrical bore 5′ with a small chamfer 14 in the transition area between the parts 1, 2; c) shows a large countersink 15 and d) shows a constriction 16 in the upper area, which, for example, is used to center the joining pin 6 in the second part 2 to be joined.

FIG. 5 shows various formations of the first contact face 3 at the point at which the welding to the joining pin 6 is to take place. Normally, no preparatory machining is required, but such machining may be advantageous in the case of special pairings of materials and/or surface conditions of the first part 1. According to a), a countersink 18 is provided; according to b), a blind bore 19. For the local removal of carbon-rich hardening layers or nitrite layers, local removal 20 only indicated in c) is sufficient. It can be carried out by chemical surface conversion, laser machining or light grinding. According to d), a dome-shaped hollow 21 is provided or, according to e), a flat countersink 22.

FIG. 6 shows various possible formations of the joining pin 6. In the normal case, a cylindrical pin 6 with a flat end face 6′ according to a) is used. Alternatively, the joining pin 6 can have a circularly symmetrical depression 23 at its end face 6′, according to b), which results in a particularly full welding bead; or, according to c), it has a dome 24 at its end face; or, according to d), a rounded tip 25. In order automatically to bring about separation of the joining pin 6 when friction welding is completed, either a sharp-edge circumferential groove 26 is provided, according to e), or the welding parameters and dimensions are chosen in such a way that, according to f), a zone 30 of elevated temperature is formed.

The circumferential groove 26 has the effect that, when a specific torque is reached, the excess part 28 of the joining pin 6 is separated from the part 27 remaining in the bore 5. This increase in torque can be applied by means of the friction welding machine itself or by means of a suitable additional device; it can already occur, without anything special being done, in the compression phase or in the repressurizing phase. A sufficiently high temperature in the zone 30 can be achieved by means of suitable design. In f), a head 29 for clamping in the clamping device of the friction welding machining is further indicated.

FIGS. 7 and 8 show a balancing shaft of the piston machine, produced by applying the method according to the invention. In the most favorably case, as here, the balancing shaft 30 is a smooth cylindrical shaft with the same diameter throughout, that is to say particularly simple and cheap to fabricate. It corresponds to the first part of FIG. 1, its surface forming the first contact face. The balancing shaft 30 is mounted in bearings 31 in a bearing block, only indicated. On said shaft, in each case between two bearings 31, balancing weights 32 are fixed in the manner according to the invention. The balancing weight 32 here is a single-piece casting which fits accurately onto the balancing shaft 30, but can also be a forged or turned part. It comprises an eccentric balancing mass 33 and two annular parts 34 surrounding the balancing shaft 30. The balancing weight corresponds to the second part of FIG. 1. The balancing weight 32 also has a thrust bearing face 35 which interacts with the bearing 31. For this reason, and because of the functional requirements on a balancing shaft, the balancing weight 32 must be fixed such that it is positioned accurately on the balancing shaft 30 both in the longitudinal and in the circumferential direction.

For the purpose of fixing, the balancing weight 32 in the exemplary embodiment illustrated has two bores 36, corresponding to bores 5 of FIG. 1. However, one bore 36 would suffice.

By virtue of the particular advantages of the method of the invention and the characteristics of the machine element according to the invention, it is possible to mount the balancing shaft unit according to FIG. 7, to clamp the mounted unit, to position the balancing weights accurately and only then to perform the friction welding. The saving in time and costs achieved in this way is extremely high, with the maximum quality, reliability and reproducibility of the joint.

1. A method of joining a first part to a second part, the first part (1) having a first contact face (3) and the second part (2) having a second contact face (4), which are cylindrical and touch each other when joined, by means of frictional welding with circularly symmetrical joining parts, consisting in the following steps:
a) the second part (2) is provided with a through bore (5) which is normal to the second contact face (4),
b) the two parts (1, 2) are brought with their machined contact faces (3, 4) into contact and, positioned in relation to each other, are firmly clamped in a friction welding machine (8),
c) as a joining part, a joining pin (6) having an end face (6′) is firmly clamped in the other clamping device (9) of a friction welding machine,
d) the joining pin (6) is inserted into the bore (5) until it reaches the first contact face (3) and then, under rotation, is pressed on in the direction of the axis of rotation, by which means a friction welded joint (11; 39) is produced between the end face of the joining pin (6) and the first part (1),
e) after the welding has been completed, the joining pin (6; 27; 37) remains at least partly in the bore (5; 36), characterized in that the bore (5) is larger than the joining part (6), so that between bore (5) and joining part (6) a space (7) is produced in which the welding bead (10) produced in step d) finds space and there produces a form-fitting joint between the wall of the bore (5) and the joining pin (6).

2. The method as claimed in claim 1, the remainder (28) of the joining pin (6) which is no longer needed after step d) being separated from the part (27; 37) that produces the joint, characterized in that the separation is carried out by tearing off and/or shearing off the unneeded part in a predetermined zone (30) of the joining pin (6).

3. A machine element, comprising a first part (1; 30) with a first cylindrical contact face (3) and a second part (2) with a second cylindrical contact face (4) and a bore (5; 36) which ends at the second contact face and accommodates a joining pin (6; 37) which passes through the bore (5; 36) and whose end face (6′) is joined to the first contact face (3) by a first friction welding zone (11; 39), characterized in that the diameter of the bore (5; 36), at least over part of its depth, is larger than that of the joining pin (6; 37), so that between bore (5) and joining pin (6) a space (7) is produced, in which the welding bead (10) which is formed produces a form-fitting joint between the first and second parts (1, 2; 30, 32).

4. The machine element as claimed in claim 3, characterized in that the joining pin (6) has an intended fracture point (26; 30).

5. The machine element as claimed in claim 4, characterized in that the intended fracture point (26) is a circumferential groove.

6. The machine element as claimed in claim 3, characterized in that the bore (5) of the second part has a widening (14; 15) in the vicinity of the second contact face.

7. The machine element as claimed in claim 3, characterized in that the bore (5) of the second part has a constriction (16) on the side facing away from the second contact face.
